(19) United States
(12) Patent Application Publication
(10) Pub. No.: US 2025/0292394 A1
(43) Pub. Date: Sep. 18, 2025

(54) SEMICONDUCTOR FABRICATION FACILITY ANALYSIS SYSTEM AND METHOD

(71) Applicant: Samsung Electronics Co., Ltd., Suwon-si (KR)

(72) Inventors: Sanghoon Han, Suwon-si (KR); Gangyong Gu, Suwon-si (KR); Eungjin Kim, Suwon-si (KR); Wontaek Oh, Suwon-si (KR)

(21) Appl. No.: 18/943,216

(22) Filed: Nov. 11, 2024

(30) Foreign Application Priority Data
Mar. 18, 2024 (KR) 10-2024-0037394

(51) Int. Cl. G06T 7/00

(52) U.S. Cl. CPC G06T 7/001; G06T 2207/30148; G06T 2207/30232

(57) ABSTRACT

A semiconductor fabrication facility analysis system includes one or more surveillance cameras configured to generate imaging data comprising captured imagery of a surveillance area within a semiconductor fabrication facility, an image preprocessing unit configured to extract an image from the imaging data, and an image analysis unit configured to analyze the image, wherein the image analysis unit includes an object detection unit configured to detect a mobile object in the image, and an object classification unit configured to determine an object classification for the mobile object based on a color analysis of the mobile object.

### CROSS-REFERENCE TO RELATED APPLICATION

This application is based on and claims priority under 35 U.S.C. § 119 to Korean Patent Application No. 10-2024-0037394, filed on Mar. 18, 2024, in the Korean Intellectual Property Office, the disclosure of which is incorporated by reference herein in its entirety.

### BACKGROUND

The inventive concept relates to a semiconductor fabrication facility analysis system and method. In particular, the inventive concept relates to a semiconductor fabrication facility analysis system and method using a machine learning model.

Numerous types of electronics include semiconductor devices fabricated in semiconductor fabrication facilities. Some tasks associated with the operation of a semiconductor fabrication facility may be performed by human workers, and different types of workers may be responsible for performing different tasks. Other tasks may be completed using various types of equipment, which in some semiconductor fabrication facilities may include mobile equipment (such as mobile robots). Due to a variety of risk factors, hazardous conditions may have the potential to arise as workers (and in some facilities, mobile equipment) move around within a facility and perform tasks.

### SUMMARY

The inventive concept provides a semiconductor fabrication facility analysis system and method, according to which risk parameters associated with workers and equipment in a semiconductor fabrication facility may be determined by classifying and monitoring the workers and equipment, and risk assessments may be conducted based on such risk parameters to check for the presence of hazardous conditions within the facility.

The technical objective to be achieved by the inventive concept is not limited to the above-described objective, and other technical objectives that are not mentioned herein would be clearly understood by a person skilled in the art from the description of the disclosure.

According to an aspect of the inventive concept, there is provided a semiconductor fabrication facility analysis system including one or more surveillance cameras configured to generate imaging data comprising captured imagery of a surveillance area within a semiconductor fabrication facility, an image preprocessing unit configured to extract an image from the imaging data, and an image analysis unit configured to analyze the image, wherein the image analysis unit includes an object detection unit configured to detect a mobile object in the image, and an object classification unit configured to determine an object classification for the mobile object based on a color analysis of the mobile object.

According to another aspect of the inventive concept, there is provided a semiconductor fabrication facility analysis system including one or more surveillance cameras configured to generate imaging data comprising captured imagery of a surveillance area within a semiconductor fabrication facility, an image preprocessing unit configured to extract an image from the imaging data and preprocess the image, and an image analysis unit configured to analyze the preprocessed image, wherein the image analysis unit includes an object detection unit configured to detect a mobile object in the preprocessed image, and an object classification unit configured to determine an object classification for the mobile object based on a color analysis of the mobile object.

According to another aspect of the inventive concept, there is provided a semiconductor fabrication facility analysis system including one or more surveillance cameras configured to generate imaging data comprising captured imagery of a surveillance area within a semiconductor fabrication facility, an image preprocessing unit configured to extract an image from the imaging data and preprocess the image, wherein the image preprocessing unit includes an image sampling unit configured to extract the image by sampling the imaging data, an image scaling unit configured to convert a size of the image, and an image format unit configured to convert a format of the image, the semiconductor fabrication facility analysis system further including an image analysis unit configured to analyze the preprocessed image, wherein the image analysis unit includes an object detection unit configured to detect a mobile object in the preprocessed image, an object tracking unit configured to track a movement path of the mobile object, an object classification unit configured to determine an object classification for the mobile object, and a risk determination unit configured to perform a risk assessment based on one or more risk parameters associated with the mobile object.

### BRIEF DESCRIPTION OF THE DRAWINGS

Embodiments of the inventive concept will be more clearly understood from the following detailed description taken in conjunction with the accompanying drawings in which:

FIG. 1 is a block diagram of a semiconductor fabrication facility analysis system according to an embodiment;

FIG. 2 is a block diagram of an image preprocessing unit according to an embodiment;

FIG. 3 is a block diagram of an image analysis unit according to an embodiment;

FIG. 4 is a flowchart showing a semiconductor fabrication facility analysis method according to an embodiment;

FIG. 5 is a flowchart showing an image preprocessing operation according to an embodiment;

FIG. 6 is a flowchart showing an image analysis operation according to an embodiment;

FIG. 7 is an image showing a heatmap in a semiconductor fabrication facility according to an embodiment;

FIG. 8 is a graph showing a movement amount of an object over time according to an embodiment;

FIG. 9 is a flowchart showing an image analysis operation according to an embodiment; and

FIG. 10 is a block diagram of a semiconductor fabrication facility analysis system according to an embodiment.

### DETAILED DESCRIPTION OF THE EMBODIMENTS

Hereinafter, embodiments of the inventive concept are described in detail with reference to the accompanying drawings, in which various embodiments are shown. The invention may, however, be embodied in many different forms and should not be construed as limited to the example embodiments set forth herein. These example embodiments are just that-examples-and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail-it is impracticable to list every possible variation for every feature described herein. The language of the claims should be referenced in determining the requirements of the invention. The same reference numerals are used for the same components in the drawings, and redundant descriptions thereof are emitted.

Throughout the specification, when a component is described as “including” a particular element or group of elements, it is to be understood that either the component is formed of only the element or the group of elements, or the element or group of elements may be combined with additional elements to form the component, unless the context indicates otherwise. The term “consisting of,” on the other hand, indicates that a component is formed only of the element(s) listed.

A “unit”, as the term is used herein, may perform at least one function or operation, and may be implemented by hardware or a combination of hardware and software.

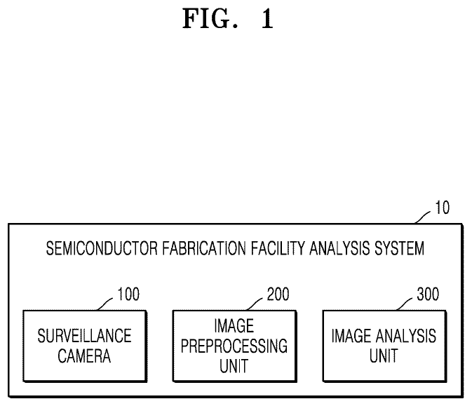

FIG. 1 is a block diagram of a semiconductor fabrication facility analysis system 10 according to an embodiment. The semiconductor fabrication facility analysis system 10 may identify, classify, analyze, and monitor objects within a semiconductor fabrication facility to detect hazardous conditions that may arise within the semiconductor fabrication facility. The objects can include mobile objects, such as humans (e.g., workers) and/or mobile equipment (e.g., mobile robotic equipment). The objects can additionally or alternatively include stationary objects, such as stationary objects having the potential to cause or contribute to hazardous conditions (e.g., hazardous chemical storage containers).

Referring to FIG. 1, the semiconductor fabrication facility analysis system 10 may include one or more surveillance cameras 100, an image preprocessing unit 200, an image analysis unit 300, and a database 310.

The surveillance camera(s) 100 may generate imaging data comprising captured imagery of a surveillance area within a semiconductor fabrication facility for the purpose of surveillance and/or security. In an embodiment, the imaging data may include one or more video streams, such as one or more digital video streams, one or more analog video streams, or a combination of both. The surveillance camera(s) 100 may include pan/tilt/zoom controllable imaging device(s) and/or stationary imaging device(s). However, the inventive concept is not limited thereto, and any device capable of generating imaging data comprising captured imagery may be used as a surveillance camera 100.

The surveillance camera(s) 100 may capture imagery of mobile objects, such as humans and/or mobile equipment, and/or stationary objects within a semiconductor fabrication facility. In an embodiment, the surveillance camera(s) 100 may also capture audio (e.g., using including microphones), and may generate audio data comprising the captured audio. In an embodiment, the surveillance camera(s) 100 may generate multimedia data, such as digital multimedia stream(s) or analog multimedia stream(s), comprising both imaging data and audio data.

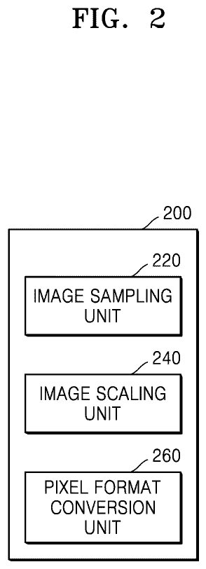

The image preprocessing unit 200 may extract images from imaging data received from the surveillance camera(s) 100, and preprocess the images. In an embodiment, the image preprocessing unit 200 may preprocess images so that the image analysis unit 300 can more readily analyze the images. The image preprocessing unit 200 is further described below with reference to FIG. 2.

The image analysis unit 300 may analyze images extracted from imaging data (such as may be comprised in digital or analog video or multimedia streams) provided by the surveillance camera(s) 100. In an embodiment, the image analysis unit 300 may analyze such images after they have been extracted and preprocessed by the image processing unit 200. In an embodiment, the image analysis unit 300 may analyze images using a deep learning model, or another type of machine learning model. The image analysis unit 300 may analyze images to detect and identify objects within the images. The objects can include mobile objects, such as humans and/or mobile equipment, and can additionally or alternatively include stationary objects. The image analysis unit 300 can track locations, states, and/or motion of objects that it detects, determine classifications for those objects, and assess whether those objects may cause or contribute to any hazardous conditions within the semiconductor fabrication facility analysis system 10.

The database 310 can contain various types of data that the image analysis unit 300 may use in conjunction with any or all of detecting, identifying, tracking, and classifying objects in the semiconductor fabrication facility analysis system 10 and assessing the potential of those objects to cause or contribute to any hazardous conditions. For instance, the database 310 can include data describing any or all of physical characteristics and/or features of a variety of objects, classifications that may be assigned to various types of objects, and risk parameters associated with various objects.

FIG. 2 is a block diagram of the image preprocessing unit 200 according to an embodiment.

Referring to FIG. 2, the image preprocessing unit 200 may include an image sampling unit 220, an image scaling unit 240, and a pixel format conversion unit 260.

The image sampling unit 220 may extract images from imaging data received from the surveillance camera(s) 100. Herein, images that the image sampling unit 220 extracts from imaging data received from the surveillance camera(s) 100 may be referred to as “frames”. In an embodiment, the image sampling unit 220 may extract frames from received imaging data by sampling the imaging data according to a sampling rate, which may represent a number of frames per unit time (e.g., frames-per-second (FPS)). The image sampling unit 220 may sample the imaging data according to a sampling rate selected to facilitate the accurate detection of motion and actions during subsequent analysis of the extracted images. In an example, the image sampling unit 220 may sample the imaging data at a sampling rate of about 3 FPS or more.

The image scaling unit 240 may convert the sizes of one or more images extracted by the image sampling unit 220. In an embodiment, the image scaling unit 240 may convert the sizes of one or more extracted images so that the image analysis unit 300 can more readily analyze those images. In an embodiment, the image scaling unit 240 may convert the sizes of one or more extracted images through pixel subsampling. In an embodiment, the image scaling unit 240 may convert the sizes of one or more extracted images so that the images provided to the image analysis unit 300 are all of a same size.

The format conversion unit 260 may convert the formats of one or more images extracted by the image sampling unit 220. In an embodiment, the format conversion unit 260 may convert the formats of one or more extracted images so that the image analysis unit 300 can more readily analyze those images. In an embodiment, the format conversion unit 260 may convert the formats of one or more extracted images so that the images provided to the image analysis unit 300 are all of a same format.

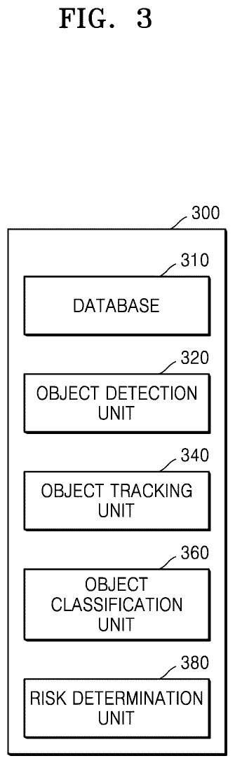

FIG. 3 is a block diagram of the image analysis unit 300 according to an embodiment.

Referring to FIG. 3, the image analysis unit 300 may include an object detection unit 320, an object tracking unit 340, an object classification unit 360, and a risk determination unit 380.

The object detection unit 320 may detect objects in images that it receives from the image preprocessing unit 200.

In an embodiment, the detected objects may include mobile objects, such as humans (e.g., workers) and/or mobile equipment (e.g., mobile robotic equipment, overhead hoist transportation (OHT)) within the semiconductor fabrication facility. In an embodiment, the detected objects may additionally or alternatively include stationary objects within the semiconductor fabrication facility, such as stationary objects having the potential to cause or contribute to hazardous conditions (e.g., hazardous chemical storage containers, stationary robotic equipment). The object detection unit 320 may further detect locations of the detected objects. In an embodiment, the object detection unit 320 may generate a heatmap showing the locations of detected objects.

The object detection unit 320 may detect objects in images based on stored information about previously detected objects. For example, the object detection unit 320 may detect an object in an image based on information indicating detection of that object in one or more other images. In an embodiment, the object detection unit 320 may detect objects by using an object recognition model. For example, the object detection unit 320 may detect objects by using a Haar-like feature model. In an embodiment, the object detection unit 320 may detect objects by using a machine learning model. In an embodiment, the object detection unit 320 may detect objects by using a deep learning model. For example, the object detection unit 320 may detect objects by using a machine learning model, such as a support vector machine (SVM) and/or a principal component analysis (PCA). For example, the object detection unit 320 may detect objects by using a neural network-based deep learning model, such as a fast/faster region convolution neural network (R-CNN), a region-based fully convolution network (RFCN), a single shot multibox (SSD), you only look once (YOLO), and/or the like. In an embodiment, the object detection unit 320 may detect objects using neural network-based bounding box regression.

The object tracking unit 340 may track, over sequences of frames, the presence and positions of objects detected by the object detection unit 320, which can include mobile objects and stationary objects. The object tracking unit 340 may determine associations between objects detected in different frames. For instance, the object tracking unit 340 may determine that an object in one frame matches (is the same object as) an object detected in a subsequent frame. The object tracking unit 340 can determine associations between objects in non-consecutive frames, such that even if an object is not detected in a given frame of a frame sequence (e.g., because the object has become occluded by a second object), the object tracking unit 340 can successfully track the object over the course of the frame sequence.

In an embodiment, the object tracking unit 340 may determine motion vectors for mobile objects that it tracks. Any given such motion vector can describe motion of a mobile object with respect to one or more dimensions. For instance, a given motion vector may describe motion along a straight line (and thus with respect to one dimension), motion within a plane (and thus with respect to two dimensions), or motion within a three-dimensional space. In an embodiment, the object tracking unit 340 may track a mobile object over multiple frames and determine a movement path of the mobile object. For example, the object tracking unit 340 may determine the movement path of the mobile object by using a Kalman filter, a combinatorial optimization algorithm (such as an algorithm based on the Hungarian method), a simple online and real-time tracking (SORT), and/or a DeepSORT model.

The object classification unit 360 may determine object classifications for objects detected by the object detection unit 320. In an embodiment, to determine an object classification for a given detected object, the object classification unit 360 may determine an object class and object type of the detected object. In an embodiment, determining the object class of a given detected object may involve determining whether that detected object is a human, a mobile non-human object (e.g., mobile equipment), or a stationary non-human object (e.g., stationary equipment). To determine an object class for a detected object, the object classification unit 360 may determine whether the detected object is mobile or stationary. In an embodiment, the object classification unit 360 can determine whether the detected object is mobile or stationary based on whether object tracking unit 340 has detected motion on the part of that detected object while tracking that detected object. If the detected object is stationary, the object classification unit 360 can determine that the detected object is a stationary non-human object. If the detected object is mobile, the object classification unit 360 can then determine whether the detected mobile object is a human (e.g., a worker) or a mobile non-human object. In an embodiment, the object classification unit 360 can determine whether the detected mobile object is a human or a mobile non-human object based on characteristics of motion of the detected mobile object, as detected by object tracking unit 340 while tracking the detected mobile object. In an embodiment, the object classification unit 360 can additionally or alternatively consider physical characteristics (e.g., size, shape, features, and/or components) of the detected mobile object in determining whether the detected mobile object is a human or a mobile non-human object.

The object classification unit 360 can determine an object type of a detected object with reference to the object class of the detected object. In an embodiment, if the detected object is a human, the object classification unit 360 can determine the object type of the detected human as one of multiple types of workers that may be present in the semiconductor fabrication facility. In an embodiment, the object classification unit 360 can determine that the detected human is a particular type of worker based on characteristics of motion of the detected human, as detected by object tracking unit 340 while tracking the detected human. For instance, the object classification unit 360 may determine that the detected human is a particular type of worker based on which areas within the semiconductor fabrication facility that the detected human has visited. If the detected object is a stationary or mobile non-human object, the object classification unit 360 can identify the detected stationary or mobile non-human object as being one of multiple types of stationary or mobile non-human objects. In an embodiment, if the detected object is a stationary non-human object, the object classification unit 360 can identify the detected stationary non-human object as being a particular type of stationary non-human object based on physical characteristics (e.g., size, shape, features, and/or components) of the detected stationary non-human object. In an embodiment, if the detected object is a mobile non-human object, the object classification unit 360 can identify the detected mobile non-human object as being a particular type of mobile non-human object based on physical characteristics (e.g., size, shape, features, and/or components) of the detected mobile non-human object, characteristics of motion of the detected mobile non-human object as detected by object tracking unit 340, or both.

In an embodiment, the object classification unit 360 may perform a color analysis of any given detected object in conjunction with determining an object type for that detected object. The color analysis that the object classification unit 360 performs on the detected object can involve identifying color(s) of outer surface(s), component(s), or covering(s) of the detected object and checking for correspondences between the identified color(s) and particular object types associated with an object class of the detected object. For instance, if the detected object is a worker, the color analysis can involve determining that the worker is a worker of a particular type based on a color of the worker's clothing. In another example, if the detected object is mobile robotic equipment, the color analysis can involve determining that the mobile robotic equipment is a particular type of mobile robot based on a color of a chassis of the mobile robotic equipment.

In an embodiment, the color analyses can involve identifying colors in the form of red, green, and blue (RGB) color representations. In another embodiment, the color analyses can involve identifying colors in the form of hue, saturation, and value (HSV) color representations, and/or Commission Internationale de l'Eclairage L*a*b* (CIELAB)—hereinafter referred to as L*a*b*—color representations, which may be less sensitive to variations in lighting intensity and/or color temperature.

The RGB color representations may represent each color as a combination of a red (R) value, a green (G) value, and a blue (B) value. The HSV color representations may represent each color as a combination of a hue (H) value, a saturation(S) value, and a brightness (V) value. The L*a*b* color representations may represent each color as a combination of a lightness (L) value, an a* value, and a b* value, where the a* and b* values represent positions on a green-red axis and a blue-yellow axis, respectively. While the RGB, HSV, and L*a*b* color representations are cited as examples, the inventive concept is not limited thereto, and color analyses performed by the object classification unit 360 may involve determining color representations according to other color representation schemes.

In an embodiment, based on an object class and object type that it determines for a detected object, the object classification unit 360 may identify one or more features of the detected object to be tracked, and the object tracking unit 340 may track state(s) of those feature(s). The feature(s) to be tracked may generally be feature(s) with respect to which knowledge of their states may facilitate tracking motion of the detected object and/or assessing potential risks associated with the detected object.

In an embodiment, with respect to a given detected object, the object tracking unit 340 may track state(s) of features including one or more joint(s). For example, after classifying a detected mobile object as a worker, the object classification unit 360 may analyze one or more images to detect one or more skeletal joints (such as elbow(s), knee(s), shoulder(s), hip(s), wrist(s), or ankle(s)) of the worker, and the object tracking unit 340 may track the state(s) of the detected skeletal joint(s). In another example, the mobile object may be classified as mobile robotic equipment, the object classification unit 360 may detect a joint of a robotic arm of the mobile robotic equipment, and the object tracking unit 340 may track the state of that joint of the robotic arm. Tracking the state(s) of the detected joint(s) of the mobile object may involve tracking any or all of an extent of flexion, extension, or rotation of the joint(s), position(s) of the joint(s) relative to other portion(s) of the mobile object (e.g., if the mobile object is a human, position(s) of the joint(s) relative to the upper torso of the human), and orientation(s) of the joint(s) (such as relative orientation(s) with respect to other portion(s) of the mobile object and/or absolute orientation(s) according to a defined frame of reference).

In an embodiment, the object tracking unit 340 may determine a posture of the mobile object. In an embodiment, the object tracking unit 340 may determine the posture of the mobile object based on the state(s) of detected joint(s) of the mobile object.

In an embodiment, the object tracking unit 340 may determine the posture of the mobile object using a posture estimation algorithm. For example, the object tracking unit 340 may determine the posture of the mobile object using a neural network-based deep learning model, such as a recurrent neural network (RNN), a long short-term memory (LSTM), a convolution neural network (3D CNN), and/or the like.

The risk determination unit 380 may check for hazardous conditions within the semiconductor fabrication facility by performing risk assessments based on risk parameters associated with objects detected by the object detection unit 320. In an embodiment, the risk parameters can include postures of the detected objects. In an embodiment, the risk parameters may be obtained from database 310.

As described above, the image preprocessing unit 200 and/or the image analysis unit 300 may each be implemented by hardware, firmware, or a combination thereof. For example, the image preprocessing unit 200 and/or the image analysis unit 300 may each be a computer, such as a workstation computer, a desktop computer, a laptop computer, a mobile device, a tablet computer, and the like. For example, the image preprocessing unit 200 and the image analysis unit 300 may include memory devices, such as read-only memory (ROM), random access memory (RAM), and the like, processors configured to perform a certain operating and algorithm, for example, a microprocessor, a central processing unit (CPU), a graphics processing unit (GPU), and the like. Furthermore, the image preprocessing unit 200 and the image analysis unit 300 may include a receiver and a transmitter for receiving and transmitting electrical signals.

The semiconductor fabrication facility analysis system 10 according to an embodiment may extract an image from imaging data comprising captured imagery of a surveillance area within a semiconductor fabrication facility and analyze the image. The semiconductor fabrication facility analysis system 10 according to an embodiment may detect a mobile object in the image. Furthermore, the semiconductor fabrication facility analysis system 10 according to an embodiment may identify one or more risk parameters associated with the mobile object and check for the existence of a hazardous condition by performing a risk assessment based on the one or more risk parameters.

In an example, the semiconductor fabrication facility analysis system 10 may identify the mobile object as a human and classify the human as a particular type of worker based on a color of clothing of the human. Furthermore, the semiconductor fabrication facility analysis system 10 may track the state(s) of one or more joints of the human, determine a posture of the human based on the state(s) of the joint(s), and include the posture of the human among the one or more risk parameters based on which it performs the risk assessment. Accordingly, the semiconductor fabrication facility analysis system 10 according to an embodiment may quickly and accurately monitor the semiconductor fabrication facility for hazardous conditions.

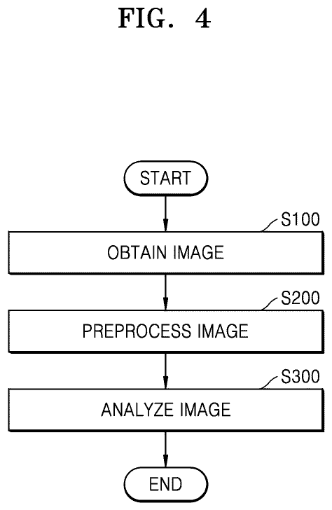

FIG. 4 is a flowchart showing a semiconductor fabrication facility analysis method according to an embodiment. The semiconductor fabrication facility analysis method is described with reference to FIGS. 1 to 3.

Referring to FIG. 4, first, an image of a area in a semiconductor fabrication facility may be obtained (S100). For instance, image preprocessing unit 200 may extract an image from imaging data generated by one or more surveillance cameras 100, and the imaging data cay comprise captured imagery of a surveillance area within a semiconductor fabrication facility.

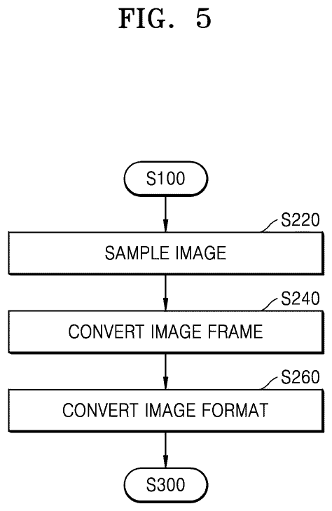

Then, the obtained image may be preprocessed (S200). For example, after extracting the image from the imaging data, image preprocessing unit 200 may preprocess the image. As described above, the image preprocessing unit 200 may preprocess the image using a machine learning model. Furthermore, the image preprocessing unit 200 may preprocess the image using a deep learning model. The process of extracting an image from imaging data and preprocessing the image is described with reference to FIG. 5.

FIG. 5 is a flowchart showing an image preprocessing operation according to an embodiment.

Referring to FIG. 5, first, the image sampling unit 220 may sample imaging data to extract an image (S220). The imaging data may be sampled according to a sampling rate selected to facilitate the accurate detection of motion and actions during subsequent analysis of the images obtained by sampling the imaging data. In an example, the image sampling unit 220 may sample the imaging data at a sampling rate of 3 FPS or more.

Then, the image scaling unit 240 may convert the size of the image (S240). The size of the image may be converted so that the image can be more readily analyzed. In an example, the size of the image may be converted using pixel subsampling.

Then, the format conversion unit 260 may convert a format of the image (S260). The format of the image may be converted to facilitate subsequent analysis of the image. In an embodiment, the format of the image may be converted to a common format of a plurality of images to be subsequently analyzed by the image analysis unit 300.

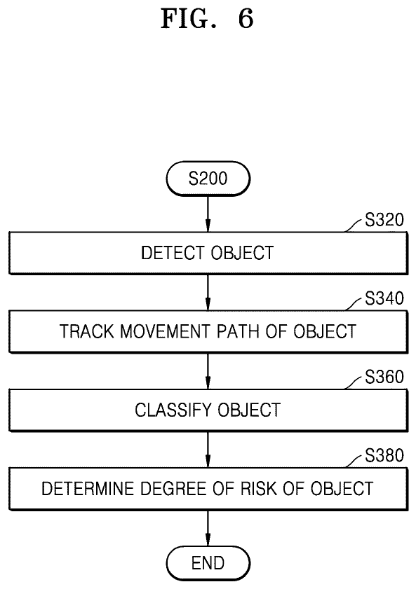

Referring back to FIG. 4, after the preprocessing of the image (S200), the image may be analyzed (S300). In other words, the image preprocessed by the image preprocessing unit 200 may be analyzed by the image analysis unit 300. As described above, the image analysis unit 300 may analyze the image preprocessed by the image preprocessing unit 200 using a machine learning model. The image analysis unit 300 may analyze the image preprocessed by the image preprocessing unit 200 using a deep learning model. The process of analyzing an image is described with reference to FIG. 6.

FIG. 6 is a flowchart showing an image analysis operation according to an embodiment.

Referring to FIG. 6, first, the object detection unit 320 may detect an object (S320) in an image. The detected object may be a human (e.g., a worker), a non-human mobile object (e.g., mobile robotic equipment or an OHT), or a stationary object. In an embodiment, the object detection unit 320 may detect the object in the image using neural network-based bounding box regression. In an embodiment, the object detection unit 320 may generate a heatmap that shows a location of the detected object within the semiconductor fabrication facility.

Then, the object tracking unit 340 may determine a movement path of the detected object (S340). The object tracking unit 340 may determine the movement path of the detected object by tracking the position of that object over a sequence of image frames.

Then, the object classification unit 360 may determine an object classification for the detected object (S360). In an embodiment, to determine the object classification for the detected object, the object classification unit 360 may determine an object class and object type of the detected object. In an embodiment, the object classification unit 360 may determine the object classification for the detected object based on a color analysis of the detected object. In an example, the detected object may be a worker, and the object classification unit 360 may determine a color of the worker's clothing by performing a color analysis, and classify the detected object as a particular type of worker based on the color of the worker's clothing. In an embodiment, the color analysis can involve identifying a color in the form of an RGB color representation, an HSV color representation, or an L*a*b* color representation.

Then, the risk determination unit 380 may determine a degree of risk of the detected object (S380). In an embodiment, the risk determination unit 380 may determine the degree of risk of the detected object based on a posture of the object. The object tracking unit 340 may determine the posture of the detected object by tracking the state(s) of one or more joints of the detected object. The risk determination unit 380 may refer to risk assessment data stored in database 310 to determine the degree of risk of the detected object based on the posture of the detected object.

The semiconductor fabrication facility analysis method according to an embodiment may involve extracting an image from imaging data comprising captured imagery of a surveillance area within a semiconductor fabrication facility and analyzing the image. The semiconductor fabrication facility analysis method according to an embodiment may involve, by analyzing the image, detect a moving object in the image. Furthermore, the semiconductor fabrication facility analysis method according to an embodiment may involve performing a risk assessment based on one or more risk parameters associated with the moving object and detecting a hazardous condition via the risk assessment.

In an embodiment, the semiconductor fabrication facility analysis method may involve determining an object classification for the mobile object based on a color analysis of the mobile object. In an embodiment, the semiconductor fabrication facility analysis method may involve determining a posture of the mobile object by tracking the state(s) of one or more joints of the mobile object.

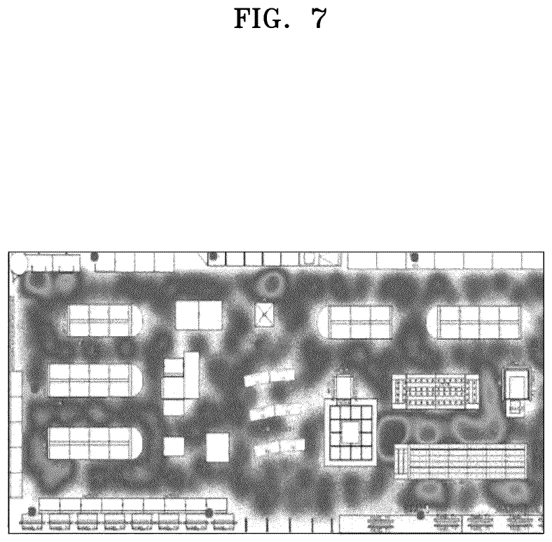

FIG. 7 is an image showing a heatmap in a semiconductor fabrication facility according to an embodiment.

Referring to FIG. 7, a heatmap is illustrated that may be obtained by calculating the density of an object by location in a semiconductor fabrication facility. As described above, the object detection unit 320 may detect an area in which an object is located, from image(s) that the image analysis unit 300 receives. In an embodiment, the object detection unit 320 may illustrate a heatmap showing a density of humans (e.g., workers) in a semiconductor fabrication facility. In another embodiment, the object detection unit 320 may illustrate a heatmap showing a density of humans and equipment in a semiconductor fabrication facility.

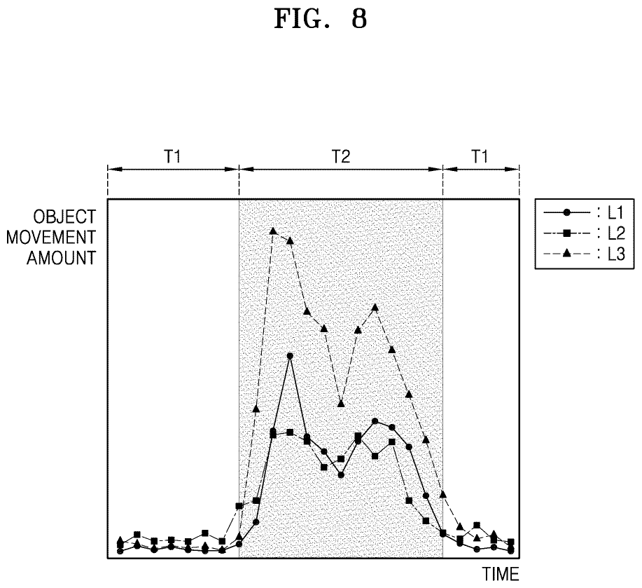

FIG. 8 is a graph showing movement amounts of objects over time according to an embodiment. In the graph of FIG. 8, a horizontal axis denotes time, and a vertical axis denotes a movement amount of an object. Illustrated in FIG, 8 are movement amounts of objects L1, L2, and L3 over time. In an embodiment, objects L1, L2, and L3 may include one or more workers. In an embodiment, objects L1, L2, and L3 may additionally or alternatively include one or more non-human mobile objects, such as mobile equipment.

Analysis of space inside a semiconductor fabrication facility may be performed based on a heatmap such as that of FIG. 7 and movement amounts such as those illustrated in FIG. 8. In an embodiment, an overall time interval may be subdivided into a first time interval Tl during which the movement amount of an object is relatively low and a second time interval T2 during which the movement amount of an object is relatively high. For example, the first time interval TI may be an off-peak time, and the second time interval T2 may be a peak time.

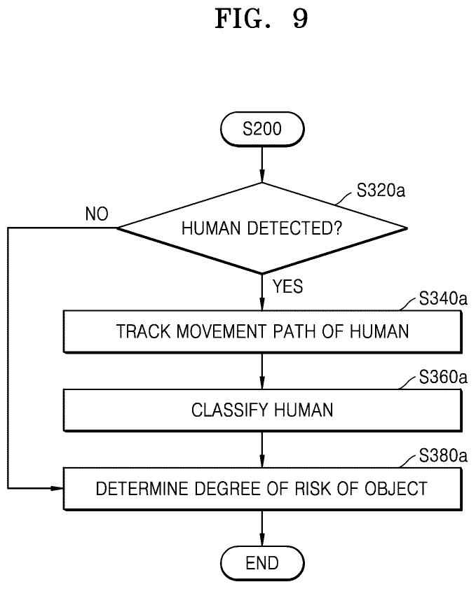

FIG. 9 is a flowchart showing an image analysis operation according to an embodiment. The image analysis operation is described with reference to FIGS. 1 to 6.

Referring to FIG. 9, a determination may be made of whether a detected object is a human (S320a). For example, an object may be detected in an image extracted from imaging data generated by one or more surveillance cameras 100, and a determination may be made of whether the detected object is a human. If the detected object is determined to be a human, operation S340a may be performed. If the detected object is determined to not be a human, operation S380a may be performed.

In conjunction with operation S340a, a movement path of the detected human may be tracked. The tracking of the movement path of the detected human according to operation S340a may be performed in a same or similar manner as the tracking of the movement path of an object according to operation S340 of FIG. 6.

In conjunction with operation S360a, the object classification unit 360 may determine an object classification for the detected human. The determination of the object classification for the detected human according to operation S360a may be performed in a same or similar manner as the determination of the object classification for the detected object according to operation S360 of FIG. 6.

In conjunction with operation S380a, the risk determination unit 380 may determine a degree of risk of the detected human. The determination of the degree of risk of the detected human according to operation S380a may be performed in a same or similar manner as the determination of the degree of risk of the detected object according to operation S380 of FIG. 6.

According to the semiconductor fabrication facility analysis method of FIG. 9, a movement path of a detected object is only tracked, and an object type of that detected object is only determined, if the detected object is determined to be a human. This may advantageously increase the efficiency of the semiconductor fabrication facility analysis system in, for example, scenarios in which mobile equipment (such as mobile robotic equipment) is not used the fabrication facility and/or scenarios in which mobile equipment moves within the fabrication facility according to predefined schedules and/or patterns.

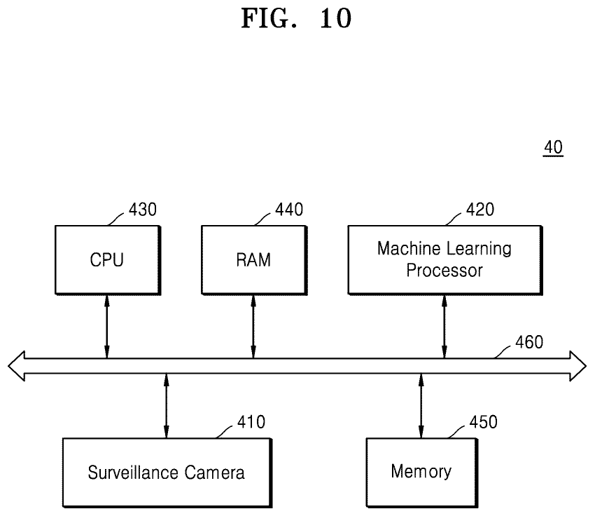

FIG. 10 is a block diagram of a semiconductor fabrication facility analysis system 40 according to an embodiment. The semiconductor fabrication facility analysis system 40 is described with reference to FIGS. 1 to 9 together.

Referring to FIG. 10, the semiconductor fabrication facility analysis system 40 may implement one or more semiconductor fabrication facility analysis methods to monitor a semiconductor fabrication facility for hazardous conditions. In conjunction with implementing the semiconductor fabrication facility analysis method(s), the semiconductor fabrication facility analysis system 40 may check for hazardous conditions by using machine learning model(s), deep learning algorithm(s), and/or neural network model(s) to preprocess images, detect, identify, classify, and/or track objects in those images, and/or perform risk assessments based on risk parameters associated with those objects. The semiconductor fabrication facility analysis system 40 may include surveillance camera(s) 410, a machine learning processor 420, a CPU 430, RAM 440, a memory 450, and a bus 460.

The semiconductor fabrication facility analysis system 40 according to an embodiment may further include general purpose components other than the components illustrated in FIG. 10. For example, the semiconductor fabrication facility analysis system 40 may further include an input/output module, a security module, a power control device, and the like, and further include various types of processors. Furthermore, according to an embodiment, at least one of the components of FIG. 10 may be omitted from the semiconductor fabrication facility analysis system 40. The components of the semiconductor fabrication facility analysis system 40 may communicate with each other through the bus 460.

The surveillance camera(s) 410 may generate imaging data comprising captured imagery of a surveillance area within a semiconductor fabrication facility. The surveillance camera(s) 410 may capture imagery of humans, things, and the like within the semiconductor fabrication facility. In an embodiment, in addition to visual information, the imaging data generated by the surveillance camera(s) 410 may include auditory information.

The machine learning processor 420 may train (or learn) a machine learning model, or infer information included in input data by analyzing input data using a machine learning model. The machine learning processor 420 may determine a situation or configure components of a mounted electronic device based on inferred information.

Furthermore, the machine learning processor 420 may receive input data from the surveillance camera(s) 410 and the memory 450, and generate output data based on the received input data. In an embodiment, the machine learning processor 420 may detect objects in images extracted from imaging data generated by the surveillance camera(s) 410.

In another embodiment, the semiconductor fabrication facility analysis system 40 may further include an additional processor, and the additional processor may detect objects in images extracted from imaging data generated by the surveillance camera(s) 410.

The machine learning processor 420 may be implemented by a neural network operation accelerator, a coprocessor, a digital signal processor (DSP), an application specific integrated circuit (ASIC), a field-programmable gate array (FPGA), a GPU, a neural processing unit (NPU), a tensor processing unit (TPU), a multi-processor system-on-chip (MPSoC), and the like.

The machine learning processor 420 may perform a machine learning algorithm, such as an SVM and/or a PCA. The type of a machine learning algorithm is not limited to an example described above.

The machine learning processor 420 may perform a neural network algorithm based on an artificial neural network (ANN), a CNN, an R-CNN, a 3D CNN, a region proposal network (RPN), an RNN, a generative adversarial network (GAN), a self-attention generative adversarial network (SAGAN), a stacking-based deep neural network (S-DNN), a state-space dynamic neural network (S-SDNN), a deconvolution network, a deep belief network (DBN), a restricted Boltzman machine (RBM), a fully convolutional network, an LSTM network, a classification network, a plain residual network, a dense network, a hierarchical pyramid network, an RFCN, an SSD, a YOLO, a transformer network and/or a vision transformer network. The type of a neural network model is not limited to an example described above.

The CPU 430 may control the overall operation of the semiconductor fabrication facility analysis system 40. The CPU 430 may include one processor core (single core) or a plurality of processor cores (multi-core). The CPU 430 may process or execute programs and/or data stored in a storage area such as the memory 450, by using the RAM 440.

For example, the CPU 430 may execute an application program (application), and control the machine learning processor 420 to perform machine learning and/or neural network-based tasks required according to the execution of an application program.

The memory 450 may store object recognition data used in an object recognition model. The object detection unit 320 may detect an object by comparing the object recognition data stored in the memory 450 with object data obtained from an image. The memory 450 may store object posture data. The risk determination unit 380 may determine a degree of risk of an object based on risk assessment data stored in the memory 450. The memory 450 may store data indicating the number and location of detected objects inside the semiconductor fabrication facility. In an embodiment, the memory 450 may store a heatmap of the semiconductor fabrication facility.

The memory 450 may include at least one of a volatile memory or a nonvolatile memory. The nonvolatile memory may include ROM, programmable ROM (PROM), electrically programmable ROM (EPROM), electrically erasable and programmable ROM (EEPROM), a flash memory, and the like. The volatile memory may include dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM), and the like. In an embodiment, the memory 450 may include at least one of a hard disk drive (HDD), a solid state drive (SSD), a compact flash (CF) card, a secure digital (SD) card, a micro secure digital (micro-SD) card, a mini secure digital (mini-SD) card, an extreme digital (xD) card, or a Memory Stick.

According to the inventive concept, images may be extracted from imaging data comprising captured imagery of a surveillance area within a semiconductor fabrication facility, and the images may be analyzed. Via the analysis of the images, objects in the images may be detected, some of which may be determined to be moving objects Furthermore, the semiconductor fabrication facility may be monitored for hazardous conditions based on characteristics, such as risk parameters, associated with the detected objects.

While the inventive concept has been particularly shown and described with reference to embodiments thereof, it will be understood that various changes in form and details may be made therein without departing from the spirit and scope of the following claims.

What is claimed is:

1. A semiconductor fabrication facility analysis system comprising:
one or more surveillance cameras configured to generate imaging data comprising captured imagery of a surveillance area within a semiconductor fabrication facility;
an image preprocessing unit configured to extract an image from the imaging data; and
an image analysis unit configured to analyze the image, wherein the image analysis unit comprises:
an object detection unit configured to detect a mobile object in the image; and
an object classification unit configured to determine an object classification for the mobile object based on a color analysis of the mobile object.

2. The semiconductor fabrication facility analysis system of claim 1, wherein the object classification unit is configured to determine the object classification based on at least one of a hue, saturation, and value (HSV) representation of a color of the mobile object and an L*a*b* representation of the color of the mobile object.

3. The semiconductor fabrication facility analysis system of claim 1, wherein the object detection unit is further configured to generate a heatmap that shows a location of the mobile object within the semiconductor fabrication facility.

4. The semiconductor fabrication facility analysis system of claim 1, wherein the object detection unit is further configured to generate a graph that shows a movement amount of the mobile object over time.

5. The semiconductor fabrication facility analysis system of claim 1, wherein the object detection unit is configured to detect the mobile object based on a machine learning model, and the machine learning model comprises at least one of a support vector machine (SVM), a principal component analysis (PCA), a fast/faster region convolution neural network (R-CNN), a region-based fully convolution network (RFCN), a single shot multibox (SSD), and you only look once (YOLO).

6. The semiconductor fabrication facility analysis system of claim 1, wherein the image analysis unit further comprises an object tracking unit configured to track a movement path of the mobile object.

7. The semiconductor fabrication facility analysis system of claim 1, wherein the mobile object is a human, and the object classification unit is configured to classify the human as a type of worker based on a color of clothing of the human.

8. A semiconductor fabrication facility analysis system comprising:
one or more surveillance cameras configured to generate imaging data comprising captured imagery of a surveillance area within a semiconductor fabrication facility;
an image preprocessing unit configured to extract an image from the imaging data and preprocess the image; and
an image analysis unit configured to analyze the preprocessed image, wherein the image analysis unit comprises:
an object detection unit configured to detect a mobile object in the preprocessed image; and
an object classification unit configured to determine an object classification for the mobile object based on a color analysis of the mobile object.

9. The semiconductor fabrication facility analysis system of claim 8, wherein the image preprocessing unit comprises:
an image sampling unit configured to extract the image by sampling the imaging data;
an image scaling unit configured to convert a size of the image; and
an image format unit configured to convert a format of the image.

10. The semiconductor fabrication facility analysis system of claim 9, wherein the image sampling unit is configured to sample the imaging data at a sampling rate of 3 frame-per-second (FPS) or more.

11. The semiconductor fabrication facility analysis system of claim 8, wherein the mobile object comprises mobile equipment.

12. The semiconductor fabrication facility analysis system of claim 8, wherein the mobile object comprises a human.

13. The semiconductor fabrication facility analysis system of claim 8, wherein the image analysis unit further comprises a risk determination unit configured to perform a risk assessment based on one or more risk parameters associated with the mobile object, wherein the one or more risk parameters include a posture of the mobile object.

14. The semiconductor fabrication facility analysis system of claim 13, wherein the object tracking unit is configured to determine the posture of the mobile object by using at least one of a recurrent neural network (RNN), a long short-term memory (LSTM), and a convolution neural network (3D CNN).

15. The semiconductor fabrication facility analysis system of claim 8, wherein the image analysis unit is configured to analyze the preprocessed image by using a machine learning model.

16. A semiconductor fabrication facility analysis system comprising:
one or more surveillance cameras configured to generate imaging data comprising captured imagery of a surveillance area within a semiconductor fabrication facility;
an image preprocessing unit configured to extract an image from the imaging data and preprocess the image, wherein the image preprocessing unit comprises:
an image sampling unit configured to extract the image by sampling the imaging data;
an image scaling unit configured to convert a size of the image; and
an image format unit configured to convert a format of the image; and
an image analysis unit configured to analyze the preprocessed image, wherein the image analysis unit comprises:
an object detection unit configured to detect a mobile object in the preprocessed image;
an object tracking unit configured to track a movement path of the mobile object;
an object classification unit configured to determine an object classification for the mobile object; and
a risk determination unit configured to perform a risk assessment based on one or more risk parameters associated with the mobile object.

17. The semiconductor fabrication facility analysis system of claim 16, wherein the object tracking unit is configured to track a movement path of the mobile object by extracting a direction vector of the mobile object.

18. The semiconductor fabrication facility analysis system of claim 16, wherein the object tracking unit is configured to track a movement path of the mobile object by using at least one of a Kalman filter, a combinatorial optimization algorithm, a simple online and real-time tracking (SORT), and a DeepSORT model.

19. The semiconductor fabrication facility analysis system of claim 16, wherein the object tracking unit is configured to track a state of a joint of the mobile object.

20. The semiconductor fabrication facility analysis system of claim 16, wherein the object tracking unit is configured to determine a posture of the mobile object based on a posture estimation algorithm, wherein the one or more risk parameters associated with the mobile object include the posture of the mobile object.
